(19) United States
(12) Patent Application Publication
(10) Pub. No.: US 2026/0139127 A1
(43) Pub. Date: May 21, 2026

(54) RUBBER COMPOSITIONS AND ARTICLES THEREOF

(71) Applicant: The Goodyear Tire & Rubber Company, Akron, OH (US)

(72) Inventors: Chenchy Jeffrey Lin, Copley, OH (US); Paul Harry Sandstrom, Cuyahoga Falls, OH (US); James Joseph Golden, North Canton, OH (US)

(21) Appl. No.: 19/343,087

(22) Filed: Sep. 29, 2025

Related U.S. Application Data
(63) Continuation-in-part of application No. 18/952,000, filed on Nov. 19, 2024.

(51) Int. Cl. C08L 7/00; B60C 1/00; C08J 3/20; C08J 3/22; C08J 3/24; C08K 3/04; C08K 3/06; C08K 3/36; C08K 5/3415

(52) U.S. Cl. CPC C08L 7/00; B60C 1/00; C08J 3/203; C08J 3/22; C08J 3/247; C08K 3/04; C08K 3/06; C08K 3/36; C08K 5/3415; C08K 2201/019; C08L 2205/025; C08L 2310/00; C08L 2312/02

(57) ABSTRACT

In one aspect, the disclosure relates to compositions comprising: an elastomer; about 1 phr to about 100 phr of a recovered carbon; about 1 phr to about 20 phr of a silica, selected from a conventional silica and a pretreated silica; and about 0.5 phr to about 15 phr of a reinforcing agent, wherein the reinforcing agent is a bismaleimide compound or a derivative thereof. The disclosure also relates to vulcanized rubber compositions and articles, such as tires or components of tires, comprising said vulcanized rubber compositions. Also disclosed herein is a method for mixing rubber, comprising a nonproductive stage and a productive stage. This abstract is intended as a scanning tool for purposes of searching in the particular art and is not intended to be limiting of the present disclosure.

This application is a continuation-in-part of U.S. Ser. No. 18/952,000 filed on Nov. 19, 2024, the disclosure of which is hereby incorporated.

### BACKGROUND

The demand for improved tire performance has resulted in the development and evaluation of new materials to produce tires with desirable properties. Improving tire properties such as rolling resistance while maintaining balances in tradeoffs can be challenging. For example, additives that improve adhesion properties of a rubber composition can also result in an increase in hysteresis of a tire produced from the rubber composition, resulting in a higher rolling resistance. There is a need for rubber formulations that strike a balance between processability, cost, low tire rolling resistance, and good adhesion properties. These needs and other needs are satisfied by the present disclosure.

There is a desire to achieve a double-digit increase-specifically, at least a 25 wt. % improvement—in sustainable material content, without compromising the performance of the tire compound. To enhance the sustainability profile of a tire composition, the invention replaces conventional fossil fuel-based carbon black with carbon black produced by burning natural gas in a tire overlay compound.

### SUMMARY

In accordance with the purpose(s) of the disclosure, as embodied and broadly described herein, the disclosure, in one aspect, relates to compositions comprising: an elastomer; a recovered carbon or carbon particle being disbursed in a masterbatch or as a freely added material; a silica, selected from a conventional silica and a pretreated silica; and about a reinforcing agent, wherein the reinforcing agent is a bismaleimide compound or a derivative thereof. Also disclosed herein are vulcanized rubber compositions and articles, such as tires or components of tires, comprising said vulcanized rubber compositions.

In another aspect, the disclosure relates to methods for mixing rubber, comprising a nonproductive stage and a productive stage. The nonproductive stage comprises: combining together an elastomer, a conventional silica, and a recovered carbon or carbon particle, thereby forming an initial mixture; and mixing the initial mixture at a temperature of about 130° C. to about 180° C., thereby forming a nonproductive mixture. The productive stage comprises: combining together the nonproductive mixture with a bismaleimide compound or a derivative thereof and a curing agent, thereby forming an intermediate mixture; and mixing the intermediate mixture at a temperature of about 90° C. to about 110° C., thereby forming a productive mixture.

Other systems, methods, features, and advantages of the present disclosure will be or become apparent to one with skill in the art upon examination of the detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### DETAILED DESCRIPTION

Many modifications and other aspects disclosed herein will come to mind to one skilled in the art to which the disclosed compositions and methods pertain having the benefit of the teachings presented in the foregoing descriptions. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation. While aspects of the present disclosure can be described and claimed in a particular statutory class, such as the composition statutory class, this is for convenience only and one of skill in the art will understand that each aspect of the present disclosure can be described and claimed in any statutory class.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure. Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein. Embodiments of the present disclosure will employ, unless otherwise indicated, techniques of material chemistry, organic chemistry, rubber mixing, rubber compounding, and the like, which are within the skill of the art. Such techniques are explained fully in the literature.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably.

As used herein, the term “and/or” includes any and all combinations of one or more of the associated listed items. Expressions like “at least one of,” when preceding a list of elements, modify the entire list of elements and do not modify the individual elements.

Nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical compound, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “an elastomer,” “an accelerator,” or “a reinforcing agent,” includes, but is not limited to, two or more such elastomers, accelerators, or reinforcing agents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be unsubstituted or substituted with one or more groups including, but not limited to, alkyl, cycloalkyl, alkoxy, amino, ether, halide, hydroxy, nitro, silyl, sulfo-oxo, or thiol, as described herein.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group where at least one of the carbon atoms of the ring is replaced with a heteroatom such as, but not limited to, nitrogen, oxygen, sulfur, or phosphorus; and is included within the meaning of the term “cycloalkyl.” The cycloalkyl group and heterocycloalkyl group can be unsubstituted or substituted with one or more groups including, but not limited to, alkyl, cycloalkyl, alkoxy, amino, ether, halide, hydroxy, nitro, silyl, sulfo-oxo, or thiol as described herein.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aryl” as used herein is a group that contains any carbon-based aromatic group including, but not limited to, benzene, naphthalene, phenyl, biphenyl, anthracene, and the like. The aryl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond, such as biaryl to two aryl groups that are bound together via a fused ring structure, as in naphthalene, or are attached via one or more carbon-carbon bonds, as in biphenyl.

The terms “rubber” and “elastomer” may be used herein interchangeably, unless indicated otherwise.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other elastomers than explicitly mentioned in the claims, provided that the phr value of the claimed rubbers/elastomers is in accordance with claimed phr ranges and the amount of all rubbers/elastomers in the composition results in total in 100 parts of rubber/elastomer.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

As used herein, the term “repeat unit” as referenced in the elastomers described herein are derived from monomers used to produce the partially saturated elastomers. For example, polybutadiene has the repeat unit as provided below.

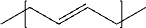

In certain aspects, when the elastomer is the polymerization product of two different monomers (e.g., A and B), the repeat unit can be represented by -A-B-.

As used herein, a “residue” of a chemical species refers to the moiety that is the resulting product of the chemical species in a particular reaction scheme or subsequent formulation or chemical product, regardless of whether the moiety is actually obtained from the chemical species. Thus, an isoprene residue in an elastomer refers to one or more —CH₂CH═C(CH₃)CH₂— units in the elastomer, regardless of whether isoprene was used to prepare the elastomer. Similarly, a butadiene residue in an elastomer refers to one or more —CH₂CH═CHCH₂— moieties in the elastomer, regardless of whether the residue is obtained by reacting sebacic acid or an ester thereof to obtain the polyester.

Unless otherwise specified, temperatures referred to herein are based on atmospheric pressure (i.e. one atmosphere).

### B. RUBBER COMPOSITIONS

In one aspect, the disclosure relates to compositions, such as uncured or cured rubber compositions, comprising an elastomer, carbon black, a silica, and a reinforcing agent. The compositions disclosed herein exhibit relatively low hysteresis and relatively high adhesion while maintaining good stiffness and processability. Furthermore, processing of the rubber compositions can require no more than two mixing passes or stages. The present disclosure also relates to methods of making the disclosed compositions and to articles, such as tires and/or components of tires, comprising the compositions.

In one aspect, the present disclosure relates to compositions comprising: an elastomer; about 1 phr to about 100 phr of a carbon black, selected from a conventional carbon black and a masterbatch carbon black; about 1 phr to about 20 phr of a silica, selected from a conventional silica and a pretreated silica; about 0.5 phr to about 15 phr of a reinforcing agent, wherein the reinforcing agent is a bismaleimide compound or derivative thereof. A masterbatch carbon black refers to a high concentration of carbon black, i.e., about 10 wt % to about 70 wt %, about 10 wt % to about 60 wt %, or about 15 wt % to 50 wt % of carbon black, dispersed in a carrier, a binder, a polymer matrix, or a combination thereof. Examples of conventional carbon black include, but are not limited to, ASTM classified N-type and S-type carbon blacks, for example N110, N121, N134, S212, N220, N231, N234, N242, N293, N299, S315, N326, N330, N332, N339, N343, N347, N351, N358, N375, N539, N550, N582, N630, N642, N650, N683, N754, N762, N765, N774, N787, N907, N908, N990, N991, or a combination thereof. In one aspect, the conventional carbon black can have an iodine absorption value of about 9 g/kg to about 145 g/kg and/or a dibutylphthalate (DBP) absorption value of about 34 cm³/g to about 150 cm³/g.

As used herein, “carbon black” refers to the material produced via incomplete combustion of heavy petroleum products using the furnace process. Commercial furnace carbon blacks are derived from controlled combustion of liquid hydrocarbons, allowing precise control over properties such as particle size and structure. Examples include N110, N220, N330, N550, N660, N772, and their blends. Tires typically incorporate multiple types of carbon black, sometimes in combination.

As used herein, “recovered carbon” (rC) and “recovered carbon black” (rCB) refer to carbon material obtained from end-of-life tires (ELTs) through pyrolysis or thermal demanufacturing. Pyrolysis involves heating ELTs in the absence of oxygen, producing a solid carbonaceous char as a co-product. This co-product may contain relatively low levels of crystalline silica compared to ground coal.

There is no limitation herein on the method of pyrolyzing ELTs; illustrative approaches are described in, inter alia, U.S. Ser. No. 10/119,031B2 and U.S. Ser. No. 11/441,038B2, with one example of rC characterized in U.S. Ser. No. 12/012,497B2. Thermal decomposition—also referred to as thermal depolymerization or thermal demanufacturing—is distinguishable from traditional pyrolysis in that it employs an oxidizing agent (e.g., air) to continue tire combustion. No limitation is made herein on the method of thermal demanufacturing ELTs; an illustrative method is described in U.S. Ser. No. 10/703,876.

One example process for converting carbon-containing feedstock into carbon particles is disclosed in U.S. Ser. No. 12/030,776 to Monolith Materials, titled “Systems and Methods for Particle Generation”, which is incorporated by reference in its entirety. The method involves generating a plasma-typically comprising at least about 60% hydrogen by volume-using plasma-generating electrodes (e.g., in a reactor), and injecting hydrocarbons (e.g., methane, ethane, or unsaturated compounds) to form carbon particles. In one embodiment, the hydrocarbon feedstock may be ELT oil obtained via pyrolysis. When introduced into the hot plasma gas, hydrogen is removed from the hydrocarbon, yielding carbon particles. As used herein, the “carbon particle” is characterized by (i) a statistical thickness surface area (m²/g)/electron microscope surface area (m²/g) (STSA/EMSA) ratio greater than or equal to about 1.3, (ii) a lattice constant (Lc) greater than about 3.0 nanometers (nm), and (iii) an STSA (m²/g)/nitrogen surface area (m²/g) (STSA/N2SA) ratio that is between about 1.01 and about 1.4, wherein the carbon particle comprises carbon black.

U.S. Ser. No. 10/119,031 B2 to Black Bear Carbon, titled “Method for Obtaining a Carbon Black Powder by Pyrolyzing Scrap Rubber, the Carbon Black Thus Obtained and the Use Thereof”, is incorporated by reference herein. It discloses a method for recycling scrap rubber by pyrolyzing it to produce a char material, followed by jet milling with compressed air or steam to obtain a carbon black powder. Pyrolysis is conducted in a multi-stage rotary kiln at controlled temperatures to reduce volatile content. The resulting recovered carbon (rC) is characterized by a particle size distribution of D50<10 μm.

U.S. Ser. No. 12/012,497B2, also to Black Bear Carbon and titled “Recovered Carbon Black and Composite Material Comprising Said Recovered Carbon Black”, is incorporated by reference herein. It characterizes one embodiment of recovered carbon (rC) as having an iodine adsorption number, measured according to ASTM D-1510-17, between 95 g/kg and 160 g/kg.

U.S. Ser. No. 11/441,038 to Bolder Industries, titled “Method for Pelletizing Carbon Black Reclaimed from Waste Tires”, is incorporated by reference herein. It discloses a process comprising thermal depolymerization of rubber segments to produce carbonaceous material; comminution to reduce agglomerate size; removal of out-of-spec agglomerates; and mixing the remaining material with a binding agent to form pellets. The resulting pellets may be uniform in diameter or a blend of different sizes.

In some embodiments, the recovered carbon (rC) may be a residual material obtained from thermally demanufacturing tires. As described in U.S. Ser. No. 10/703,876 to PRTI, titled “Apparatus and Method for Thermally Demanufacturing Tires and Other Waste Products”—incorporated by reference in its entirety—rC can be isolated from a retort chamber used to generate liquid carbonaceous fuels and gaseous products.

The sustainable recovered carbon materials or carbon particles used in the elastomer composites described herein may exist in various forms. These include, but are not limited to, graphite (including pyrolytic graphite), graphene, turbostratic graphene, recovered carbon black (rCB), fibrous carbon, buckminster fullerenes (e.g., buckyballs), single-wall carbon nanotubes, and multi-wall carbon nanotubes. In one aspect, the carbon material is manufactured by Monolith Materials. In another aspect, it is manufactured by Black Bear Carbon (Netherlands) Bolder Industries (Colorado).

In one embodiment, the composition comprises a blend of conventional carbon black and recovered carbon or carbon particles, each of which may be included as part of a masterbatch or added independently during mixing. In a further aspect, the composition comprises a coupling agent. The coupling agent can include an organosilane compound or a derivative thereof. The organosilane compound or a derivate thereof can be present in the composition in an amount of from about 0.1 wt % to about 10 wt %, about 0.1 wt % to about 8 wt %, about 0.1 wt % to about 6 wt %, about 0.1 wt % to about 4 wt %, about 0.1 wt % to about 2 wt %, about 2 wt % to about 10 wt %, about 0.1 wt % to about 1 wt, about 5 wt % to about 10 wt %, or about 7 wt % to about 10 wt % of the silica. In another aspect, the coupling agent does not comprise an organosilane compound or a derivative thereof. In another aspect, the composition does not comprise an organosilane compound or a derivative thereof.

In another aspect, the compositions can comprise from about 1 phr to about 100 phr, about 10 phr to about 100 phr, about 20 phr to about 100 phr, about 30 phr to about 100 phr, about 1 phr to about 90 phr, about 1 phr to about 80 phr, about 1 phr to about 70 phr, about 10 phr to about 90 phr, about 10 phr to about 80 phr, about 20 phr to about 80 phr, about 20 phr to about 70 phr, about 20 phr to about 60 phr, or about 20 phr to about 50 phr of a carbon black. In another aspect, the composition can comprise from about 1 phr to about 20 phr, about 1 phr to about 15 phr, about 1 phr to about 10 phr, or about 1 phr to about 5 phr of the silica. In another aspect, the composition comprises from about 0.5 phr to about 15 phr, about 0.5 phr to about 10 phr, about 0.5 phr to about 5 phr, about 1 phr to about 15 phr, about 1 phr to about 10 phr, about 1 phr to about 15 phr, or about 1 phr to about 4 phr of the reinforcing agent.

The elastomer can comprise repeat units formed by residues of monomers selected from one or more of ethylene, propylene, isobutene, butadiene, isoprene, styrene, acrylonitrile, and any combination thereof. In another aspect, the elastomer can be selected from isoprene-isobutylene-rubber (Butyl rubber, IIR), halogenated isoprene-isobutylene-rubber (HIIR), ethylene-propylene-diene-terpolymer (EPDM), styrene-butadiene copolymer (SBR), acrylonitrile-butadiene copolymer (AB), acrylonitrile-butadiene-styrene copolymer (ABS), polybutadiene, natural rubber, cis-polyisoprene, and any combination thereof. In a further aspect, the elastomers generally having a number average molecular weight (Mn) between 100,000 Da and 500,000 Da. Molecular weight Mn may be determined by methods known in the art, such as by gel permeation chromatography following ASTM D3536 or equivalent.

In one aspect, the silica can be a pretreated silica, such as a pre-silanized silica, and can comprise an alkylsilane, an alkoxysilane, an organoalkoxysilyl polysulfide, or an organomercaptoalkoxysilane bonded to the silica. In another aspect, the pretreated silica can include a silica with a sulfur-containing silane bonded to the silica. In one aspect, the sulfur-containing silane can include an alkoxyorganomercaptosilane or a bis(3-triethoxysilylpropyl)polysulfide, with an average of about 2 to 5 connecting sulfur atoms in its polysulfidic bridge. Examples of pre-silanized silicas suitable for use in the compositions described herein include, but are not limited to, Ciptane® 255 LD and Ciptane® LP (PPG Industries); silicas that have been pre-treated with a mercaptosilane; Coupsil® 8113 (Degussa); Coupsil® 6508; and Agilon® 400, 454, and 458 silica from PPG Industries.

In one aspect, the pretreated silica can be treated with a silica dispersing aid. Such silica dispersing aids may include amines, amides, glycols, such as fatty acids, diethylene glycols, polyethylene glycols, fatty acid esters of hydrogenated or non-hydrogenated C5 or C6 sugars, and polyoxyethylene derivatives of fatty acid esters of hydrogenated or non-hydrogenated C5 or C6 sugars. Exemplary fatty acids include stearic acid, palmitic acid and oleic acid. Exemplary fatty acid esters of hydrogenated and non-hydrogenated C5 and C6 sugars (e.g., sorbose, mannose, and arabinose) include, but are not limited to, the sorbitan oleates (such as sorbitan monooleate, dioleate, trioleate, and sesquioleate) as well as sorbitan esters of laurate, palmitate, and stearate fatty acids. Exemplary polyoxyethylene derivatives of fatty acid esters of hydrogenated and non-hydrogenated C5 and C6 sugars include, but are not limited to, polysorbates and polyoxyethylene sorbitan esters, which are analogous to the fatty acid esters of hydrogenated and non-hydrogenated sugars noted above except that ethylene oxide groups are placed on each of the hydroxyl groups. Example of amine and amide compounds can include diphenyl guanidine or any C1-C20 alkyl amine or C1-C20 alkyl amide.

The silica can also be a conventional silica, i.e., a non-pretreated silica. The conventional silica can include precipitated silica, such as those obtained by the acidification of a soluble silicate, e.g., sodium silicate. Conventional silicas can be characterized by a Brunauer-Emmett-Teller (BET) surface area, as measured using nitrogen gas. In one aspect, the BET surface area can be in the range of about 40 m2/g to about 600 m2/g or about 80 m2/g to about 300 m2/g. The BET method of measuring surface area is described in the Journal of the American Chemical Society, Volume 60, Page 304 (1930). In a further aspect, the conventional silica can be characterized by having a DBP absorption value in a range of about 100 cm³/g to about 400 cm³/g or about 150 cm³/g to about 300 cm³/g. In one aspect, the conventional silica can have an average ultimate particle size in the range of about 0.01 μm to about 0.05 μm as determined by an electron microscope. In other aspects, the silica particles are smaller than 0.01 μm. In other aspects, the silica particles are larger than 0.05 μm. In one aspect, commercially available silicas are used, such as silicas commercially available from PPG Industries under the Hi-Sil trademark (with designations 210, 243, and the like); silicas available from Rhodia (with designations of Z1165MP and Z165GR); and silicas available from Degussa AG (with designations of VN2, VN3, and the like). In another aspect, silica obtained from rice husk ash (RHA) can be used. Rice husks are a renewable resource that can be used to create modified silica particles. Examples of commercial RHA silicas include NZEROSIL-brand silicas (e.g., granulated NZEROSIL RH-255EG, microgranular NZEROSIL RH-350MG, and high surface area granulated NZEROSIL RH-230G). (COMBINED WITH GYP2023-310) These silicas can be readily obtained from Oriental Silicas Corp. of Taiwan.

The reinforcing agent can be a bismaleimide compound or a derivative thereof. In one aspect, the reinforcing agent has a formula represented by the following structure:

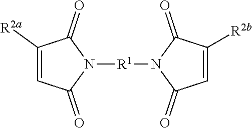

wherein R¹ can be an alkyl group, an alkenyl group, an alkynyl group, a cycloalkyl group, a cycloalkenyl group, a cycloalkynyl group, or an aryl group; and R^{2a} and R^{2b} can be individually selected from a hydrogen and an alkyl group. In a further aspect, R¹ can be an aryl group comprising no more than two aromatic rings. In a further aspect, R^{2a} and R^{2b} can both be hydrogen. In another aspect, the reinforcing agent can be selected from the group consisting of N,N′-ethylene-bismaleimide; N,N′-butylene-bismaleimide; N,N′-(m-phenylene)bismaleimide; N,N′-(p-phenylene)bismaleimide; N,N′-hexamethylene-bismaleimide; N,N′-4,4′-diphenylmethane-bismaleimide; N,N′-4,4′-diphenylether-bismaleimide; N,N′-4,4′-diphenylsulfone-bismaleimide; N,N′-4,4′-dicyclohexylethane-bismaleimide; N,N′-xylylene-bismaleimide; N,N′-diphenylcyclohexane-bismaleimide; N,N′-(p-tolylene)bismaleimide; N,N′-(methylenedi-p-phenylene)bismaleimide; N,N′-(oxydi-p-phenylene)bismaleimide; α,α-bis-(4-phenylene)bismaleimide; N,N′-(m-xylylene)biscitraconimide; α,α-bis-(4-maleimidophenyl)metadiisopropylbenzene; and a combination thereof.

The compositions disclosed herein can further include about 0.1 phr to about 10.0 phr, about 0.5 phr to about 10.0 phr, or about 0.5 phr to about 5.0 phr of a vulcanizing or curing agent. The vulcanizing agent can include elemental sulfur, a sulfur-containing silane, or a combination thereof. Additionally, the uncured rubber composition can further include an accelerator. Accelerators can be preferably but not necessarily used to control the time and/or temperature required for vulcanization and to improve the properties of a vulcanized composition. The composition can include a vulcanizing accelerator in the amount of about 0.1 phr to about 10.0 phr, about 0.5 phr to about 10.0 phr, or about 0.5 phr to about 5.0 phr. Examples of accelerators include, but are not limited to, sulfenamides (e.g., N-cyclohexyl-2-benzothiazolesulfenamide, N-tertbutyl-2-benzothiazolesulfenamide); dithiocarbamates (e.g., zinc diethyl dithiocarbamate, zinc N-dibutyl dithiocarbamate); thiazoles (e.g., 2-mercaptobenzothiazole, 2,2′-dithiobenzothiazol); and guanidines (e.g., diphenylguanidine, 1,3-di-o-tolylguanidine).

The compositions can comprise additional components, such as an oil, zinc oxide, fatty acids, retarders, and/or anti-degradants. In one aspect, the oil is a processing oil. The processing oil can be included in the composition as an extending oil typically used to extend elastomers. The processing oil can also be included in the elastomer composition by addition of the oil directly during rubber compounding. The processing oil used can include both an extending oil present in the elastomers and a process oil added during compounding. Suitable processing oils include, but are not limited to, various oils as are known in the art, including aromatic, paraffinic, naphthenic, vegetable oils, and low PCA oils, such as MES, TDAE, SRAE, and heavy naphthenic oils. Suitable vegetable oils include, for example, soybean oil, sunflower oil, and canola oil which are in the form of esters containing a certain degree of unsaturation. Examples of fatty acids include, but are not limited to, stearic acid, palmitic acids, oleic acid, and mixtures thereof. Anti-degradants can include antioxidants and antiozonants. Representative antioxidants include, but are not limited to, phenylene diamine compounds (e.g., diphenyl-p-phenylenediamine), hydroquinoline compounds (e.g., anti-polymerized trimethyl dihydroquinoline), amine compounds, dithiocarbamate compounds, phenolic compounds, phosphite compounds, toluimidazole compounds, and others, such as those disclosed in The Vanderbilt Rubber Handbook (1978), Pages 344 through 346. Representative antiozonants include, but are not limited to, N-phenyl-N′-(1,3-dimethylbutyl)-p-phenylenediamine (6PPD) and N,N′-dixylene-p-phenylenediamine (DTPD). Retarders can include, but are not limited to, phthalic anhydrides, N-(cyclohexylthio)phthalimide, benzoic acid, salicylic acid, and sulfonamide.

Described herein are vulcanized or cured rubber compositions, where any of the compositions described herein have been vulcanized. In one aspect, the vulcanized rubber compositions have improved stiffness, hysteresis, and adhesion properties compared to equivalent cured composition that do not include the reinforcing agent.

The vulcanized rubber compositions can have a stiffness that is at least 10% higher or, in another aspect, from about 10% to about 30% higher than the stiffness of an equivalent composition that does not comprise the reinforcing agent. Stiffness of a composition can be indicated by one of the dynamic storage modulus of the vulcanized rubber composition (measured at a dynamic strain amplitude of 1%, 10%, 15%, or 50%, at a temperature of about 100° C., and a frequency of about 1 HZ) or the tensile modulus of the vulcanized rubber composition (measured at 100%, 200%, or 300%). In another aspect, the vulcanized rubber compositions can have a normalized hysteresis loss that is equal to, lower than, or at least about 2% lower than the normalized hysteresis loss of an equivalent composition that does not comprise the reinforcing agent. In a further aspect, the vulcanized rubber compositions can have a normalized hysteresis loss that is about 2% to about 10% lower than the normalized hysteresis loss of an equivalent composition that does not comprise the reinforcing agent. Normalized hysteresis loss can be measured by one of the tan δ (measured at a dynamic strain amplitude of 10%, a temperature of 100° C., and a frequency of 1 Hz) or the rebound resilience (in accordance with ASTM D7121, measured at a temperature of 100° C.). Tan δ can be quantified as the ratio of the loss modulus (G″) to the storage shear modulus, i.e., G″/G′. In another aspect, the vulcanized rubber compositions can have a fabric cord adhesion that is at least about 5% greater or at least about 10% greater or, in another aspect, about 10% to about 30% greater than the fabric cord adhesion of an equivalent composition that does not comprise the reinforcing agent, where the fabric cord adhesion is measured at a temperature of 100° C. against nylon fabric and polyester fabric. Further details regarding methods for testing the various properties of the compositions can be found in the Examples.

### C. PREPARATION AND APPLICATIONS OF RUBBER COMPOSITIONS

The compositions disclosed herein can be compounded by methods generally known in the rubber compounding art, such as mixing the elastomer, recovered carbon particles and/or carbon black, silica, and reinforcing agent with various vulcanizable constituent rubbers and various commonly used additive materials such as: curing/vulcanizing agents, such as sulfur donors (e.g., elemental sulfur); curing aids, such as activators, accelerators, and retarders; processing additives such as oils, resins (including tackifying resins), and plasticizers; fillers, such as the recovered carbon particles and/or carbon black and silica; pigments; fatty acids; zinc oxide; waxes; antidegradants, such as antioxidants and antiozonants; and peptizing agents. Depending on the intended use of the vulcanizable and vulcanized material (rubbers), the additives mentioned above are selected and commonly used in conventional amounts. In one aspect, zinc oxide can be included in the rubber compositions in amounts of about 1 phr to about 5 phr. In another aspect, processing additives can be included in the rubber compositions in amounts of about 1 phr to about 50 phr. In a further aspect, resins can be included in amounts of about 0.5 phr to about 10 phr or about 0.5 phr to about 5 phr. In another further aspect, oils can be included in amounts of about 0.5 phr to about 10 phr or about 0.5 phr to about 5 phr. In another aspect, antidegradants, including antioxidants and antiozonants, can be included in amounts of about 0.5 phr to about 15 phr or about 0.5 phr to about 10 phr. Representative antidegradants include those listed previously. In one aspect, fatty acids are included in amounts of about 0.5 phr to about 3 phr. Examples of fatty acids include, but are not limited to, stearic acid, palmitic acids, oleic acid, and mixtures thereof. In one aspect, waxes are included in amounts of about 1 phr to about 5 phr. Microcrystalline waxes, paraffinic waxes, and combinations thereof can be used. In another aspect, curing/vulcanizing agents can be included in amounts of about 0.1 phr to about 10.0 phr, about 0.5 phr to about 10.0 phr, or about 0.5 phr to about 5.0 phr. In another aspect, curing aids, including activators, accelerators, and retarders, can be included in amounts of about 0.1 phr to about 10.0 phr, about 0.5 phr to about 10.0 phr, or about 0.5 phr to about 5.0 phr. Representative accelerators and retarders include those listed previously.

The compositions disclosed herein can be mixed by methods known in the rubber mixing art. For example, the ingredients can be mixed in at least two stages, namely, at least one nonproductive stage followed by a productive mix stage. In one aspect, the mixing of the uncured composition comprises only a single nonproductive stage. The final curatives including curing or vulcanizing agents may be typically mixed in the final stage, conventionally called the “productive” mix stage. In the productive mix stage, mixing typically occurs at a temperature, or ultimate temperature, lower than the mix temperature(s) of any preceding nonproductive mix stage(s). In one aspect, the mixing stages can comprise thermomechanical mixing, generally characterized by mechanical working in a mixer (e.g., internal batch mixer) or extruder for a period of time at an elevated temperature suitable to produce a rubber. The appropriate duration of the thermomechanical mixing varies as a function of the operating conditions and the volume and nature of the components. For example, the thermomechanical mixing may be from about 0.5 to 10 minutes.

In one aspect, the method for mixing rubber can comprise a nonproductive stage and a productive stage. The nonproductive stage can include combining together an elastomer, about 1 phr to about 20 phr of a conventional silica, and about 10 phr to about 100 phr of a recovered carbon particles, thereby forming an initial mixture; and mixing the initial mixture at a temperature of about 130° C. to about 180° C., thereby forming a nonproductive mixture. The productive stage can include combining together the nonproductive mixture with about 0.5 phr to about 15 phr of a bismaleimide compound or a derivative thereof and a curing agent, thereby forming an intermediate mixture; and mixing the intermediate mixture at a temperature of about 90° C. to about 110° C., thereby forming a productive mixture. In another aspect, the method for mixing rubber consists of a single nonproductive stage and a single productive stage.

This disclosure also provides for articles that incorporate any of the compositions disclosed herein. In one aspect, the article comprises a tire, such as a pneumatic tire, or a component of a tire. The tire can be a race tire, passenger tire, aircraft tire, agricultural tire, off-the-road tire, truck or bus tire, or the like. The tire can also be a radial or bias. The component of the tire can be a tread, base, sidewall, apex, chafer, sidewall insert, overlay, wirecoat, innerliner, or a combination thereof. In another aspect, the component of the tire including the composition can be a tread, base, sidewall, apex, overlay, wirecoat, ply coat, or any combination thereof. Vulcanization of the disclosed tires is generally carried out at conventional temperatures ranging from about 100° C. to about 200° C. or from about 110° C. to about 180° C. Such tires can be built, shaped, molded and cured by various methods which are known and will be readily apparent to those having skill in such art.

### D. ASPECTS

The following listing of exemplary aspects supports and is supported by the disclosure provided herein.

Aspect 1. A composition, comprising an elastomer; about 1 phr to about 100 phr of a recovered carbon particles; about 1 phr to about 20 phr of a silica, selected from a conventional silica and a pretreated silica; and about 0.5 phr to about 15 phr of a reinforcing agent, wherein the reinforcing agent is a bismaleimide compound or derivative thereof.

Aspect 2. The composition of aspect 1, wherein the composition further comprises a coupling agent.

Aspect 3. The composition of aspect 1, wherein the composition further comprises a coupling agent comprising an organosilane compound or a derivative thereof.

Aspect 4. The composition of aspect 3, wherein the organosilane compound or derivative thereof is present in the composition in a weight percentage of from about 0.1% to about 10% of the silica.

Aspect 5. The composition of aspect 3, wherein the organosilane compound or derivative thereof is present in the composition in a weight percentage of from about 0.1% to about 5% of the silica.

Aspect 6. The composition of aspect 1, wherein the composition further comprises a coupling agent that does not comprise an organosilane compound or a derivative thereof.

Aspect 7. The composition of aspect 1, wherein the composition does not comprise an organosilane compound or a derivative thereof.

Aspect 8. The composition of any one of aspects 1-7, wherein the composition comprises from about 20 phr to about 80 phr of the recovered carbon.

Aspect 9. The composition of any one of aspects 1-8, wherein the composition comprises from about 1 phr to about 15 phr of the silica.

Aspect 10. The composition of any one of aspects 1-9, wherein the composition comprises from about 1 phr to about 4 phr of the reinforcing agent.

Aspect 11. The composition of any one of aspects 1-10, wherein the reinforcing agent has a formula represented by the following structure:

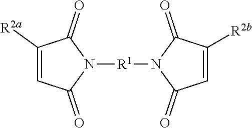

wherein, R¹ is an alkyl group, an alkenyl group, an alkynyl group, a cycloalkyl group, a cycloalkenyl group, a cycloalkynyl group, or an aryl group; and R^{2a} and R^{2b} are individually selected from a hydrogen and an alkyl group.

Aspect 12. The composition of aspect 11, wherein R¹ is an aryl group comprising no more than two aromatic rings.

Aspect 13. The composition of aspect 11 or aspect 12, wherein R^{2a} and R^{2b} are hydrogen.

Aspect 14. The composition of any one of aspects 1-11, wherein the reinforcing agent is selected from the group consisting of N,N′-ethylene-bismaleimide; N,N′-butylene-bismaleimide; N,N′-(m-phenylene)bismaleimide; N,N′-(p-phenylene)bismaleimide; N,N′-hexamethylene-bismaleimide; N,N′-4,4′-diphenylmethane-bismaleimide; N,N′-4,4′-diphenylether-bismaleimide; N,N′-4,4′-diphenylsulfone-bismaleimide; N,N′-4,4′-dicyclohexylethane-bismaleimide; N,N′-xylylene-bismaleimide; N,N′-diphenylcyclohexane-bismaleimide; N,N′-(p-tolylene)bismaleimide; N,N′-(methylenedi-p-phenylene)bismaleimide; N,N′-(oxydi-p-phenylene)bismaleimide; α,α-bis-(4-phenylene)bismaleimide; N,N′-(m-xylylene)biscitraconimide; α,α-bis-(4-maleimidophenyl)metadiisopropylbenzene; and any combination thereof.

Aspect 15. The composition of any one of aspects 1-11, wherein the reinforcing agent is N,N′-m-phenylene-bismaleimide.

Aspect 16. The composition of any one of aspects 1-15, wherein the elastomer comprises repeat units formed from residues of monomers selected from one or more of ethylene, propylene, isobutene, butadiene, isoprene, styrene, acrylonitrile, and any combination thereof.

Aspect 17. The composition of any one of aspects 1-16, wherein the elastomer comprises isoprene-isobutylene-rubber, halogenated isoprene-isobutylene-rubber, ethylene-propylene-diene-terpolymer, styrene-butadiene rubber, acrylonitrile-butadiene rubber, acrylonitrile-butadiene-styrene copolymer, polybutadiene, natural rubber, cis polyisoprene, or any combination thereof.

Aspect 18. The composition of any one of aspects 1-17, wherein the elastomer comprises natural rubber and styrene butadiene rubber.

Aspect 19. A vulcanized rubber composition, comprising the composition of any one of aspects 1-18 that has been vulcanized.

Aspect 20. An article comprising the vulcanized rubber composition of aspect 19.

Aspect 21. The article of aspect 20, wherein the article comprises a tire or a component of a tire.

Aspect 22. The article of aspect 21, wherein the component of the tire comprises a tread, base, sidewall, overlay, apex, wirecoat, ply coat, or any combination thereof.

Aspect 23. A composition, comprising an elastomer; about 1 phr to about 100 phr of a recovered carbon or carbon black, selected from a component of masterbatch or a freely added filler material, about 1 phr to about 20 phr of a conventional silica; and about 0.5 phr to about 15 phr of a reinforcing agent, wherein the reinforcing agent is a bismaleimide compound or a derivative thereof.

Aspect 24. The composition of aspect 23, wherein the composition further comprises a coupling agent.

Aspect 25. The composition of aspect 23, wherein the composition further comprises a coupling agent comprising an organosilane compound or a derivative thereof.

Aspect 26. The composition of aspect 25, wherein the organosilane compound or derivative thereof is present in the composition in a weight percentage of from about 0.1% to about 10% of the silica.

Aspect 27. The composition of aspect 25, wherein the organosilane compound or derivative thereof is present in the composition in a weight percentage of from about 0.1% to about 5% of the silica.

Aspect 28. The composition of aspect 23, wherein the composition further comprises a coupling agent that does not comprise an organosilane compound or a derivative thereof.

Aspect 29. The composition of aspect 23, wherein the composition does not comprise an organosilane compound or a derivative thereof.

Aspect 30. A vulcanized rubber composition, comprising the composition of any one of aspects 23-30 that has been vulcanized.

Aspect 31. The vulcanized rubber composition of aspect 30, wherein the vulcanized rubber composition has a stiffness that is at least 10% higher than the stiffness of an equivalent composition that does not comprise the reinforcing agent; and wherein the stiffness is indicated by one of the dynamic storage modulus of the vulcanized rubber composition, measured at a dynamic strain amplitude of 1%, 10%, 15%, or 50%, at a temperature of about 100° C., and a frequency of about 1 HZ, or the tensile modulus of the vulcanized rubber composition, measured at 100%, 200%, or 300%.

Aspect 32. The vulcanized rubber composition of aspect 30 or aspect 31, wherein the vulcanized rubber composition has a stiffness that is about 10% to about 30% higher than the stiffness of an equivalent composition that does not comprise the reinforcing agent; and wherein the stiffness is indicated by one of the dynamic storage modulus of the vulcanized rubber composition, measured at a dynamic strain amplitude of 1%, 10%, 15%, or 50%, at a temperature of about 100° C., and a frequency of about 1 HZ, or the tensile modulus of the vulcanized rubber composition, measured at 100%, 200%, or 300%.

Aspect 33. The vulcanized rubber composition of any one of aspects 30-32, wherein the vulcanized rubber composition has a normalized hysteresis loss that is equal to or lower than the normalized hysteresis loss of an equivalent composition that does not comprise the reinforcing agent; and wherein normalized hysteresis loss is measured by one of the tan δ, measured at a dynamic strain amplitude of 10%, a temperature of 100° C., and a frequency of 1 Hz, or the rebound resilience, measured at a temperature of 100° C.

Aspect 34. The vulcanized rubber composition of any one of aspects 30-33, wherein the vulcanized rubber composition has a normalized hysteresis loss, expressed as tan δ, that is about 2% to about 10% lower than the normalized hysteresis loss of an equivalent composition that does not comprise the reinforcing agent; and wherein normalized hysteresis loss is measured by one of the tan δ, measured at a dynamic strain amplitude of 10%, a temperature of 100° C., and a frequency of 1 Hz, or the rebound resilience, measured at a temperature of 100° C.

Aspect 35. The vulcanized rubber composition of any one of aspects 30-34, wherein the vulcanized rubber composition has a fabric cord adhesion that is at least 5% greater than the fabric cord adhesion of an equivalent composition that does not comprise the reinforcing agent; and wherein the fabric cord adhesion is measured at a temperature of 100° C. against nylon fabric and polyester fabric.

Aspect 36. The vulcanized rubber composition of any one of aspects 30-35, wherein the vulcanized rubber composition has a fabric cord adhesion that is at least 10% greater than the fabric cord adhesion of an equivalent composition that does not comprise the reinforcing agent; and wherein the fabric cord adhesion is measured at a temperature of 100° C. against nylon fabric and polyester fabric.

Aspect 37. The vulcanized rubber composition of any one of aspects 30-36, wherein the vulcanized rubber composition has a fabric cord adhesion that is about 10% to about 30% greater than the fabric cord adhesion of an equivalent composition that does not comprise the reinforcing agent; and wherein the fabric cord adhesion is measured at a temperature of 100° C. against nylon fabric and polyester fabric.

Aspect 38. An article comprising the vulcanized rubber composition of any one of aspects 30-37.

Aspect 39. The article of aspect 38, wherein the article comprises a tire or a component of a tire.

Aspect 40. The article of aspect 39, wherein the component of the tire comprises a tread, base, sidewall, apex, overlay, wirecoat, ply coat, or any combination thereof.

Aspect 41. A method for mixing rubber, comprising a nonproductive stage and a productive stage, wherein the nonproductive stage comprises combining together an elastomer, about 1 phr to about 20 phr of a conventional silica, and about 10 phr to about 100 phr of a recovered carbon or carbon black, selected from a component of masterbatch or a freely added filler material, thereby forming an initial mixture; and mixing the initial mixture at a temperature of about 130° C. to about 180° C., thereby forming a nonproductive mixture; and the productive stage comprises combining together the nonproductive mixture with about 0.5 phr to about 15 phr of a bismaleimide compound or a derivative thereof and a curing agent, thereby forming an intermediate mixture; and mixing the intermediate mixture at a temperature of about 90° C. to about 110° C., thereby forming a productive mixture.

Aspect 42. The method of aspect 41, wherein the intermediate mixture is formed using about 0.5 phr to about 5 phr of the curing agent.

Aspect 43. The method of aspect 41 or aspect 42, wherein the nonproductive stage further comprises combining together at least one of a fatty acid, zinc oxide, a processing oil, an antidegradant, or an antioxidant to form the initial mixture.

Aspect 44. The method of any one of aspects 41-43, wherein the productive stage further comprises combining together at least one of an accelerator or a retarder to form the intermediate mixture.

From the foregoing, it will be seen that aspects herein are well adapted to attain all the ends and objects hereinabove set forth together with other advantages which are obvious, and which are inherent to the structure. While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims. Since many possible aspects may be made without departing (COMBINED WITH GYP2023-310) from the scope thereof, it is to be understood that all matter herein set forth or shown in the accompanying detailed description is to be interpreted as illustrative and not in a limiting sense. It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text, there is no intent to limit aspects of the present disclosure to this description. On the contrary, the intent is to cover all alternatives, modifications, and equivalents included within the spirit and scope of the present disclosure.

### E. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Evaluation of Rubber Compositions

Three rubber compositions comprising a polybutadiene rubber and natural rubber-based matrix are provided in Table 1. Notable differences between the compositions include the type of silica used (pretreated vs non-pretreated), the major filler used (carbon black vs silica), the presence or absence of a silica coupling agent, phenolic resins, and the type of crosslinking agent used. Additionally, the compositions vary in the number of mixing stages, being either a two pass mix or a three pass mix. Reducing the number of mixing passes required to process a rubber composition can reduce cost associated with producing a tire from the rubber composition.

In Table 2, compared to the Control composition, Experimental rubber compositions 1 and 2 have higher stiffness (measured as the dynamic storage modulus, G′); similar or lower hysteresis (tangent delta); higher rebound resilience; and improved tensile mechanical properties. Additionally, the Experimental rubber compositions are produced using only two mix passes. Tires comprising the Experimental rubber compositions are likely to have better rolling resistance compared to tires comprising the Control composition, since lower hysteresis and higher rebound resilience contribute to an overall lower rolling resistance in a tire.

TABLE 1
Rubber Compositions. Ingredient amounts given in phr.

| | Mixing | | Experi- | Experi- |
|---|---|---|---|---|
| Ingredient | Stage | Control | mental 1 | mental 2 |
| Natural Rubber | NP1 | 65 | 65 | 65 |
| Styrene Butadiene | NP1 | 35 | 35 | 35 |
| Rubber | | | | |
| Carbon Black | NP1 | — | 35 | 35 |
| Precipitated Silica | NP1 | — | 2.5 | 2.5 |
| Pretreated Silica¹ | NP1 | 35 | — | — |
| Processing Oil | NP1 | 1.5 | 3.5 | 3.5 |
| Antioxidant² | NP1 | — | 1 | 1 |
| Antiozonant³ | NP1 | — | 1 | 1 |
| Zinc Oxide | NP1 | — | 3 | 3 |
| Fatty Acid | NP1 | — | 1 | 1 |
| phenolic resins | NP2 | 2.35 | — | — |
| Antioxidant² | NP2 | 1 | — | — |
| Zinc Oxide | NP2 | 4 | — | — |
| Fatty Acid | NP2 | 2.65 | — | — |
| Curing/Vulcanizing | PR | 3.21 | 3.1 | 3.1 |
| agent⁴ | | | | |
| Coupling Agent⁵ | PR | 2 | — | — |
| Crosslinking Agent⁶ | PR | 1.1 | — | — |
| Reinforcing Agent⁷ | PR | — | 2 | 1 |
| Accelerator⁸ | PR | — | 1.9 | 1.9 |
| Accelerator⁹ | PR | 1.48 | — | — |
| Retarder¹⁰ | PR | 0.1 | 0.1 | 0.1 |
| Total Parts | | 154.39 | 154.1 | 153.1 |

¹AGILON ® silica from the Pittsburgh Plate Glass Company
²hydroquinoline compound
³phenylenediamine compound
⁴insoluble sulfur
⁵mixture of high abrasion furnace carbon black and a bifunctional organo-silane including bis [3-(triethoxysily)propyl] tetrasulfide
⁶72.5% hexamethoxymethylmelamine on a silica carrier
⁷N,N′-(m-phenylene)bismaleimide
⁸sulfenamide compound
⁹sulfenamide and guanidine compounds
¹⁰N-(cyclohexylthio)phthalimide

TABLE 2
Physical Properties.

| | | | |
|---|---|---|---|
| | | Experi- | Experi- |
| Property | Control | mental 1 | mental 2 |

Rubber Process Analyzer 505 Properties

| | | | |
|---|---|---|---|
| Storage Modulus (G′)¹, Uncured (MPa) | 0.189 | 0.201 | 0.19 |
| G′ (MPa) at 1% strain amplitude² | 0.992 | 1.172 | 1.105 |
| G′ (MPa) at 10% strain amplitude² | 0.951 | 1.081 | 1.028 |
| G′ (MPa) at 15% strain amplitude² | 0.937 | 1.052 | 1.002 |
| G′ (MPa) at 50% strain amplitude² | 0.751 | 0.835 | 0.806 |
| Tangent Delta at 10% strain³ | 0.029 | 0.029 | 0.027 |

Zwick Rebound Test Properties⁴

| | | | |
|---|---|---|---|
| Rebound (%) | 82.39 | 84.15 | 84.15 |

Tensile Mechanical Properties⁵

| | | | |
|---|---|---|---|
| 100% Modulus (MPa) | 1.78 | 2.06 | 2.03 |
| 200% Modulus (MPa) | 4.56 | 5.55 | 5.34 |
| 300% Modulus (MPa) | 9.48 | 10.3 | 9.84 |
| Tensile Strength (MPA) | 12.98 | 13.89 | 13.09 |
| Elongation at Break (%) | 356 | 373 | 365 |
| Energy to Break | 5.89 | 7.15 | 6.32 |

Hot U-Adhesion (Fabric Adhesion)

| | | | |
|---|---|---|---|
| Maximum Force (N)⁶ | 140 | 174 | 174 |
| Maximum Force (N)⁷ | 137 | 163 | 152 |

Global Strebler Adhesion⁸

| | | | |
|---|---|---|---|
| Steady State Average Load (N) | 18.27 | 26.24 | 20.75 |
| Strebler (N/mm) | 3.88 | 5.4 | 4.06 |
| Average Force @ Average Value (N) | 21.08 | 27.96 | 19.9 |

Global Fabric Strebler Adhesion⁹

| | | | |
|---|---|---|---|
| Steady State Average Load (N) | 7.38 | 12.17 | 8.58 |
| Strebler (N/mm) | 1.54 | 2.69 | 1.85 |
| Average Force @ Average Value (N) | 15.13 | 18.24 | 16.23 |

¹measured at a 15% strain amplitude, temperature of 100° C., and frequency of 0.83 Hz
²measured at a temperature of 100° C. and frequency of 1 Hz
³measured at a 10% strain amplitude, temperature of 100° C., and frequency of 1 Hz
⁴measured at a temperature of 100° C. in accordance with ASTM D7121
⁵measured in accordance with ASTM D412
⁶adhesion to polyester
⁷adhesion to nylon
⁸adhesion to self at 100° C.
⁹adhesion to nylon at 100° C.

As shown supra, Experimental rubber compositions 2 and 3 are strong directional indicators showing improvement. In Table 3, a recovered carbon particle, comprising carbon black is used in place of the conventional carbon black. Compared to the Experimental rubber compositions 1 and 2, it is shown in Table 4 that Experimental rubber compositions 3 and 4 (comprising bio-CB) have higher stiffness (measured as the dynamic storage modulus, G′); similar or lower hysteresis (tangent delta); higher rebound resilience; and improved tensile mechanical properties. Additionally, the Experimental rubber compositions 4 and 5 are produced using only two mix passes, thus improving production efficiency. Tires comprising the Experimental rubber compositions 3 and 4 also have better rolling resistance compared to tires comprising the Control composition (Table 1), since lower hysteresis and higher rebound resilience contribute to an overall lower rolling resistance in a tire.

TABLE 3
Rubber Compositions. Ingredient amounts given in phr.

| | Mixing | Experi- | Exp 4 | Exp 5 |
|---|---|---|---|---|
| Ingredient | Stage | mental 3 | (bio-CB) | (bio-CB) |
| Natural Rubber | NP1 | 65 | 65 | 65 |
| Styrene Butadiene Rubber | NP1 | 35 | 35 | 35 |
| Carbon Black | NP1 | 35 | | |
| | | | 35 | 40 |
| Precipitated Silica | NP1 | 2.5 | 2.5 | 2.5 |
| Processing Oil | NP1 | 3.5 | 3.5 | 3.5 |
| Antioxidant² | NP1 | 1 | 1 | 1 |
| Antiozonant³ | NP1 | 1 | 1 | 1 |
| Zinc Oxide | NP1 | 3 | 3 | 3 |
| Fatty Acid | NP1 | 1 | 1 | 1 |
| Curing/Vulcanizing agent⁴ | PR | 3.1 | 3.1 | 3.1 |
| Reinforcing Agent⁷ | PR | 2 | 2 | 2 |
| Accelerator⁸ | PR | 1.9 | 1.9 | 1.9 |

TABLE 4
Physical Properties.

| | Experi- | | |
|---|---|---|---|
| | mental | Exp 4 | Exp 5 |
| Property | 3 | (bio-CB) | (bio-CB) |
| Sustainability material content % | 44.5 | 67.2 | 68.2 |
| Storage Modulus (G′)¹, Uncured (MPa) | | | |
| G′ (MPa) at 1% strain amplitude² | | | |
| G′ (MPa) at 10% strain amplitude² | 1.02 | 1.03 | 1.14 |
| G′ (MPa) at 15% strain amplitude² | 0.22 | 0.22 | 0.23 |
| G′ (MPa) at 50% strain amplitude² | 0.88 | 0.91 | 0.97 |
| Tangent Delta at 10% strain³ | 0.029 | 0.023 | 0.028 |
| Rebound (%) | 83.12 | 84.15 | 82.35 |
| 100% Modulus (MPa) | 2.19 | 2.06 | 2.43 |
| 200% Modulus (MPa) | 5.64 | 4.94 | 5.77 |
| 300% Modulus (MPa) | 10.37 | 8.91 | 9.98 |
| Tensile Strength (MPA) | 17.71 | 15.16 | 16.22 |
| 16E22longation at Break (%) | 434 | 425 | 429 |
| Energy to Break | 11.80 | 10.47 | 9.36 |
| Maximum Force (N)⁶ | | | |
| Maximum Force (N)⁷ | | | |
| Steady State Average Load (N) | | | |
| Strebler (N/mm) | | | |
| HOT U Adhesion (220) to polyester (N) | 182 | 182 | 172 |
| HOT U Adhesion (220) to nylon (N) | 131 | 153 | 162 |
| Seat Cord Adhesion Rt (225) polyester | 157 | 160 | 179 |
| Seat Cord Adhesion Rt (225) nylon | 177 | 157 | 191 |

Properties of a rubber composition can be determined before, during, or after cure using a rubber process analyzer. Rubber composition Experimental 1 has a similar uncured storage modulus to the Control rubber composition (Table 2), indicating that they have a similar uncured viscosity. For properties of a cured rubber composition provided in Table 2 (storage modulus, G′, and tan delta), the rubber composition was cured in a testing cavity at a temperature of 191° C. at 3.5% strain amplitude at 1.7 Hz for 4.88 minutes prior to obtaining the values. Stiffness of a rubber composition can be characterized using the dynamic storage modulus value of the composition. A larger storage shear modulus value indicates a stiffer compound. The Experimental rubber compositions exhibit a higher stiffness (ranging from about 7% to about 18% higher) compared to the Control composition.

Tangent delta (tan δ) is the ratio of the loss modulus (G″) to the dynamic storage modulus, i.e., G″/G′, of the cured rubber composition. A higher tan δ indicates more energy loss per stiffness of a compound. Tan δ provides a means of measuring hysteresis, or the amount of energy lost per cycle during deformation of an elastomer. Since hysteresis accounts for the majority of rolling resistance, an elastomer or composition with a lower tan delta can indicate a lower rolling resistance for a tire comprising said elastomer or composition. The Experimental rubber compositions exhibit the same or lower tan δ (ranging from about 0% to about 7% lower) compared to the Control composition.

The Zwick Rebound test can be used to determine the resilience of rubber (rebound resilience), within a range of impact strain and strain rate, by means of the impacting and measuring apparatus conforming to the requirements described in the test method according to ASTM D7121. The test is conducted at a sample temperature of 100° C. Resilience is recorded as pendulum rebound height after the pendulum hits a rubber sample. The higher the rebound value, the less energy is loss due to the pendulum's impact on the rubber sample. At 100° C., higher rebound can be associated with lower hysteresis and a lower tire rolling resistance. The Control and Experimental rubber compositions were cured at 170° C. for 10 minutes prior to testing. The Experimental rubber compositions exhibit a higher rebound value (about 2% higher) compared to the Control composition.

A cured/vulcanized rubber composition's tensile mechanical properties, such as tensile stress, modulus at various strains, and elongation at break, can be measured using the ASTM D412 test procedure. Briefly, a Die C dumbbell shaped rubber sample of known dimensions is placed in an extensometer and then clamped in grips of a force displacement machine. The rubber sample is pulled at a set rate of 500 mm/min until it breaks. The Control and Experimental rubber compositions were cured at 170° C. for 10 minutes prior to testing. The Experimental rubber compositions exhibit higher stiffness (ranging from about 4% to about 21% higher), higher tensile strength (ranging from about 1% to about 7% higher), greater elongation at break (ranging from about 3% to about 5% longer), and higher energy to break (ranging from about 7% to about 21% higher) compared to the Control composition.

The hot U-adhesion test is used as a rapid method of evaluating the relative adhesion of various types of dipped cord to rubber. Dipped cord samples are embedded in a 6.35 mm (¼ inch) strip of rubber using a special mold and inserts. The inserts are held in a heater block and cords pulled from the rubber using a pulley type holder. The maximum force required to pull each cord from the rubber is recorded. The higher force to pull out the cord, the better rubber-cord adhesion. Prior to testing, the Control and Experimental rubber compositions were cured at 170° C. for 23 minutes. For the hot U-adhesion tests reported herein, a preheat time of 3 minutes and a pulling speed of 305 cm/min was used. The Experimental rubber compositions exhibit a higher adhesion to both polyester (about 24% higher) and nylon (ranging from about 11% to about 19% higher) compared to the Control composition.

The Strebler adhesion test measures the interfacial adhesion of cured rubber compounds by pulling a sample in a T-peel manner using a force displacement machine. A defined area, or window, created by a mask between the surfaces of the sample is subjected to the test. Samples may consist of two layers of the same compound, or two different compounds adhered together (Global Strebler), to determine the adhesion between rubbers. Variations in surface treatment can also be used (such as fabric, Global Fabric Strebler) to determine the adhesion between rubber and fabric. The higher the force to peel off, the higher adhesion. Prior to testing, the Control and Experimental rubber compositions were cured at 170° C. for 11 minutes or 23 minutes for measuring Strebler adhesion and fabric Strebler adhesion, respectively. For the tests reported herein, a pulling speed of 500 mm/min was used along with a curing pressure of 100 psi. Composition Experimental 1 exhibits higher adhesion to both itself (about 33% higher, average force @average value) and nylon (about 21% higher, average force @average value) compared to the Control composition. Rubber composition Experimental 2 exhibits higher adhesion to nylon (about 7% higher for average force @average value) compared to the Control composition.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A composition, comprising:
an elastomer;
about 1 phr to about 100 phr of a recovered carbon or carbon particle, the recovered carbon or carbon particle being disbursed in a masterbatch or freely added material;
about 1 phr to about 20 phr of a silica, selected from a conventional silica and a pretreated silica; and
about 0.5 phr to about 15 phr of a reinforcing agent, wherein the reinforcing agent is a bismaleimide compound or a derivative thereof.

2. The composition of claim 1, wherein the composition further comprises a coupling agent comprising an organosilane compound or a derivative thereof, wherein the organosilane compound or derivative thereof is present in the composition in a weight percentage of from about 0.1% to about 10% of the silica.

3. The composition of claim 1, wherein the composition does not comprise an organosilane compound or a derivative thereof.

4. The composition of claim 1, wherein the composition comprises from about 20 phr to about 80 phr of the recovered carbon or carbon particle.

5. The composition of claim 1, wherein the composition comprises from about 1 phr to about 35 phr of the silica.

6. The composition of claim 1, wherein the composition comprises from about 1 phr to about 4 phr of the reinforcing agent.

7. The composition of claim 1, wherein the reinforcing agent has a formula represented by the following structure: 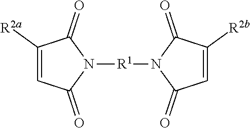
wherein,
R¹ is an alkyl group, an alkenyl group, an alkynyl group, a cycloalkyl group, a cycloalkenyl group, a cycloalkynyl group, or an aryl group; and
R^{2a} and R^{2b} are individually selected from a hydrogen and an alkyl group.

8. The composition of claim 6, wherein R¹ is an aryl group comprising no more than two aromatic rings.

9. The composition of claim 1, wherein the reinforcing agent is selected from the group consisting of N,N′-ethylene-bismaleimide; N,N′-butylene-bismaleimide; N,N′-(m-phenylene)bismaleimide; N,N′-(p-phenylene)bismaleimide; N,N′-hexamethylene-bismaleimide; N,N′-4,4′-diphenylmethane-bismaleimide; N,N′-4,4′-diphenylether-bismaleimide; N,N′-4,4′-diphenylsulfone-bismaleimide; N,N′-4,4′-dicyclohexylethane-bismaleimide; N,N′-xylylene-bismaleimide; N,N′-diphenylcyclohexane-bismaleimide; N,N′-(p-tolylene)bismaleimide; N,N′-(methylenedi-p-phenylene)bismaleimide; N,N′-(oxydi-p-phenylene)bismaleimide; α,α-bis-(4-phenylene)bismaleimide; N,N′-(m-xylylene)biscitraconimide; α,α-bis-(4-maleimidophenyl)metadiisopropylbenzene; and any combination thereof.

10. The composition of claim 1, wherein the elastomer comprises repeat units formed from residues of monomers selected from one or more of ethylene, propylene, isobutene, butadiene, isoprene, styrene, acrylonitrile, and any combination thereof.

11. A vulcanized rubber composition, comprising the composition of claim 1 that has been vulcanized.

12. An article comprising the vulcanized rubber composition of claim 10.

13. The article of claim 11, wherein the article comprises a tire or a component of a tire.

14. A composition, comprising:
an elastomer;
about 1 phr to about 100 phr of a recovered carbon or carbon particle, the recovered carbon or carbon particle being disbursed in a masterbatch or freely added material;
about 1 phr to about 20 phr of a conventional silica; and
about 0.5 phr to about 15 phr of a reinforcing agent, wherein the reinforcing agent is a bismaleimide compound or a derivative thereof.

15. A vulcanized rubber composition, comprising the composition of claim 13 that has been vulcanized.

16. The vulcanized rubber composition of claim 14, wherein the vulcanized rubber composition has a stiffness that is at least 10% higher than the stiffness of an equivalent composition that does not comprise the reinforcing agent; and wherein the stiffness is indicated by one of the dynamic storage modulus of the vulcanized rubber composition, measured at a dynamic strain amplitude of 1%, 10%, 15%, or 50%, at a temperature of about 100° C., and a frequency of about 1 HZ, or the tensile modulus of the vulcanized rubber composition, measured at 100%, 200%, or 300%.

17. The vulcanized rubber composition of claim 14, wherein the vulcanized rubber composition has a fabric cord adhesion that is at least 10% greater than the fabric cord adhesion of an equivalent composition that does not comprise the reinforcing agent; and wherein the fabric cord adhesion is measured at a temperature of 100° C. against nylon fabric and polyester fabric.

18. An article comprising the vulcanized rubber composition of claim 14.

19. The article of claim 17, wherein the article comprises a tire or a component of a tire.

20. A method for mixing rubber, comprising a nonproductive stage and a productive stage, wherein:
the nonproductive stage comprises:
combining together an elastomer, about 1 phr to about 20 phr of a conventional silica, and about 10 phr to about 100 phr of a recovered carbon or carbon particle; and
mixing the initial mixture at a temperature of about 130° C. to about 180° C., thereby forming a nonproductive mixture; and
the productive stage comprises:
combining together the nonproductive mixture with about 0.5 phr to about 15 phr of a bismaleimide compound or a derivative thereof and about 0.5 phr to about 5 phr of a curing agent, thereby forming an intermediate mixture; and
mixing the intermediate mixture at a temperature of about 90° C. to about 110° C., thereby forming a productive mixture.
